(19) United States
(12) Patent Application Publication
(10) Pub. No.: US 2021/0367937 A1
(43) Pub. Date: Nov. 25, 2021

(54) CONTROL DEVICE AND CONTROL METHOD

(71) Applicant: KABUSHIKI KAISHA TOKAI RIKA DENKI SEISAKUSHO, Aichi (JP)

(72) Inventors: Yosuke OHASHI, Aichi (JP); Yosuke HASEGAWA, Aichi (JP); Takanori MATSUYAMA, Aichi (JP)

(73) Assignee: KABUSHIKI KAISHA TOKAI RIKA DENKI SEISAKUSHO, Aichi (JP)

(21) Appl. No.: 17/229,221

(22) Filed: Apr. 13, 2021

(30) Foreign Application Priority Data
May 25, 2020 (JP) 2020-090676

(51) Int. Cl. H04L 29/06

(52) U.S. Cl. CPC H04L 63/0853; H04L 63/0861

(57) ABSTRACT

An object of the present invention is to provide a control device and control method that make it possible to prevent an unnecessary authentication process from being executed.

Provided is a control device including a control section configured to perform an authentication process of authenticating another device by using information obtained through communication with the other device. In the case where a predetermined condition is satisfied, the control section performs control in such a manner that the authentication process is not performed.

### CROSS REFERENCE TO RELATED APPLICATION(S)

This application is based upon and claims benefit of priority from Japanese Patent Application No. 2020-090676, filed on May 25, 2020, the entire contents of which are incorporated herein by reference.

### BACKGROUND

The present invention relates to a control device and a control method.

In recent years, technologies of authenticating a device in accordance with a result of transmitting/receiving a signal between devices have been developed. For example, JP H11-208419A discloses a technology of authenticating a portable device by transmitting/receiving a signal between an in-vehicle device and the portable device.

However, the conventional technology has a problem that there is a possibility of executing an unnecessary authentication process depending on situations.

Accordingly, the present invention is made in view of the aforementioned problem, and an object of the present invention is to provide a novel and improved control device and control method that make it possible to prevent the unnecessary authentication process from being executed.

### SUMMARY

To solve the above-described problems, according to an aspect of the present invention, there is provided a control device including a control section configured to perform an authentication process of authenticating another device by using information obtained through communication with the other device. In the case where a predetermined condition is satisfied, the control section performs control in such a manner that the authentication process is not performed.

To solve the above-described problems, according to an aspect of the present invention, there is provided a control method including performing control in such a manner that a processor performs an authentication process of authenticating another device by using information obtained through communication with the other device. In the case where a predetermined condition is satisfied, control is performed in such a manner that the authentication process is not performed.

As described above, according to the present invention, it is possible to prevent an unnecessary authentication process from being executed.

### BRIEF DESCRIPTION OF THE DRAWINGS

FIG. 1 is a diagram illustrating an example of a configuration of a system according to an embodiment of the present invention.

FIG. 2 is a flowchart illustrating an example of a flow of an operation process of a control unit according to the embodiment.

FIG. 3 is a sequence diagram illustrating an example of a flow of a ranging process according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Configuration Example

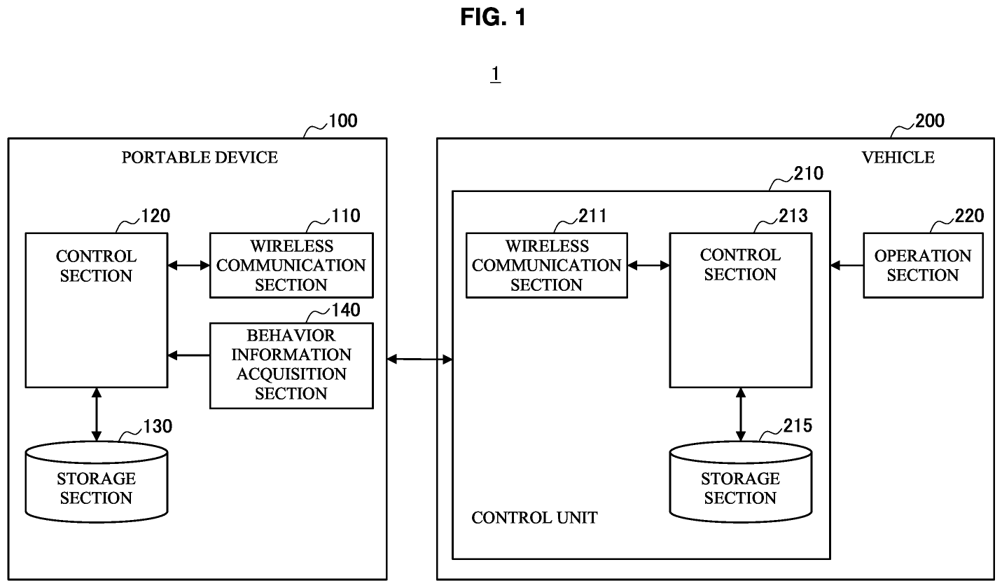

FIG. 1 is a diagram illustrating an example of a configuration of a system 1 according to an embodiment of the present invention. As illustrated in FIG. 1, the system 1 according to the present embodiment includes a portable device 100 and a control unit 210. The control unit 210 according to the present embodiment is installed in a vehicle 200. The vehicle 200 is an example of a target (target object) to be used by a user. In addition, the vehicle 200 is provided with an operation section 220. The operation section is an example of a mounted device, which is a device installed in the target object. The operation section 220 receives an operation performed by the user.

A control device and another device are involved in the present invention. The control device includes a control section configured to perform an authentication process of authenticating the other device by using information obtained through communication with the other device. The other device is an authenticatee. In the example illustrated in FIG. 1, the portable device 100 is an example of the other device, and the control unit 210 is an example of the control device. When a user (for example, a driver of the vehicle 200) carrying the portable device 100 approaches the vehicle 200, the system 1 performs wireless communication for authentication between the portable device 100 and the control unit 210 of the vehicle 200. Next, when the authentication succeeds, the vehicle 200 becomes available for the user by opening a door lock of the vehicle 200 or starting an engine of the vehicle 200. The system 1 is also referred to as a smart entry system. Next, respective structural elements will be described sequentially.

(1-1) Portable Device 100

The portable device 100 is configured as any device to be carried and used by the user. Examples of the any device include an electronic key, a smartphone, a wearable terminal, and the like. As illustrated in FIG. 1, the portable device 100 includes a wireless communication section 110, a control section 120, a storage section 130, and a behavior information acquisition section 140.

The wireless communication section 110 has a function of performing communication with the control unit 210 in conformity with a predetermined wireless communication standard. For example, in the case of the predetermined wireless communication standard, an ultra-wideband (UWB) signal is used. An impulse UWB signal has a property that makes it possible to perform ranging with high accuracy. In other words, it is possible for the impulse UWB signal to measure air propagation time of a radio wave with high accuracy by using the radio wave of ultra-short pulse width of a nanosecond or lower, and it is possible to perform ranging with high accuracy on the basis of the propagation time. Here, the ranging means measurement of a distance between devices that transmit and receive the signal.

The wireless communication section 110 transmits and receives a signal for measuring a distance between devices in a ranging process. The ranging process is a process for measuring the distance between the devices.

An example of the signal used in the ranging process is a ranging signal. The ranging signal is a signal transmitted and received for measuring the distance between the devices. The ranging signal also serves as a measurement target signal. For example, time taken to transmit or receive the ranging signal is measured. For example, the ranging signal is configured in a frame format that does not include a payload part for storing data. In the ranging process, a plurality of the ranging signals may be transmitted and received between devices. Among the plurality of ranging signals, a ranging signal transmitted from one device to another device is also referred to as a first ranging signal, in this specification. Alternatively, a ranging signal transmitted from the device that has received the first ranging signal to the device that has transmitted the first ranging signal is also referred to as a second ranging signal.

The ranging signal may be transmitted and received as the UWB signal. The wireless communication section 110 is configured as a communication interface that makes it possible to perform communication by using the UWB signals.

The control section 120 has a function of controlling overall operation performed by the portable device 100. For example, the control section 120 controls the wireless communication section 110 to perform communication with the control unit 210. In addition, the control section 120 reads information from the storage section 130 and writes information into the storage section 130. The control section 120 also functions as an authentication control section that controls an authentication process between the portable device 100 and the control unit 210. For example, the control section 120 includes an electronic circuit such as a microprocessor and a central processing unit (CPU).

The storage section 130 has a function of storing various kinds of information for operating the portable device 100. For example, the storage section 130 stores a program for operating the portable device 100, and an identifier (ID), password, and authentication algorithm for authentication, etc. For example, the storage section 130 includes a storage medium such as flash memory and a processing device that performs recording/playback on/of the storage medium.

The behavior information acquisition section 140 acquires behavior information indicating behavior of the user. For example, the behavior information includes information including movement of a body of the user. More specifically, the behavior information acquisition section 140 may be implemented by a sensor that detects movement of the portable device 100 such as an acceleration sensor that detects acceleration, a gyro sensor that detects angular velocity, a geomagnetic sensor that detects a direction, or a camera. In this case, the behavior information acquisition section 140 may detects movement (such as gesture) of a hand or the like that is holding the portable device 100, as the movement of the body of the user carrying the portable device 100. Examples of the movement include walking, running, stopping, jumping, and the like. The behavior information acquisition section 140 may be implemented by a combination of at least two selected from a group consisting of the acceleration sensor, the gyro sensor, the geomagnetic sensor, and the camera. In addition, the behavior information acquisition section 140 may be implemented by a switch such as a push-button switch that detects pressing force or a touch switch that detects touch. In this case, the behavior information acquisition section 140 acquires an operation performed on the switch by the user carrying the portable device 100, as the behavior information indicating the behavior of the user. The behavior information acquired by the behavior information acquisition section 140 is output to the control section 120. Next, the control section 120 transmits the behavior information from the wireless communication section 110 to the control unit 210.

(1-2) Control Unit 210

The control unit 210 is prepared in association with the vehicle 200. Here, the control unit 210 is assumed to be installed in the vehicle 200. For examples of the installation position, the control unit 210 may be installed in a vehicle interior of the vehicle 200, may be built in the vehicle 200 as a control module or a communication module, or may be installed in other ways. Alternatively, the control unit 210 may be prepared as a separate object from the target to be used by the user in such a manner that the control unit 210 is installed in a parking space for the vehicle 200 or in other manners. In this case, the control unit 210 may wirelessly transmit a control signal to the vehicle 200 on the basis of a result of communication with the portable device 100 and may remotely control the vehicle 200. As illustrated in FIG. 1, the control unit 210 includes a wireless communication section 211, a control section 213, and a storage section 215.

The wireless communication section 211 has a function of performing communication with portable device 100 in conformity with a predetermined wireless communication standard. The wireless communication section 211 is configured as a communication interface that makes it possible to perform communication by using the UWB signals, for example.

The control section 213 has a function of controlling overall operation performed by the control unit 210. As an example, the control section 213 controls the wireless communication section 211, communicates with the portable device 100, reads information from the storage section 215, and writes information into the storage section 215. The control section 213 also functions as an authentication control section that controls the authentication process between the portable device 100 and the control unit 210. In addition, the control section 213 also functions as a door lock control section that controls the door lock of the vehicle 200, and opens and closes the door lock. In addition, the control section 213 also functions as a light control section that controls whether to turn on or off a light installed in the vehicle 200. In addition, then control section 213 also functions as an electronic part control section that controls supply of electric power to a predetermined electronic part installed in the vehicle 200, and starts/stops supply of electric power to the predetermined electronic part. Examples of the “predetermined electronic part” include an air conditioner, a car audio device, a car navigation device, and the like. The control section 213 also functions as an engine control section that controls the engine of the vehicle 200, and starts/stops the engine. Note that, a motor or the like may be installed as a driving source of the vehicle 200 in addition to or instead of the engine. For example, the control section 213 may be configured as an electronic control unit (ECU).

Note that, the control section 213 is an example of a control section that controls operation of the control device according to the present invention.

The storage section 215 has a function of storing various kinds of information for operating the control unit 210. For example, the storage section 215 stores a program for operating the control unit 210, an authentication algorithm, and the like. For example, the storage section 215 includes a storage medium such as flash memory and a processing device that performs recording/playback on/of the storage medium.

(1-3) Operation Section 220

The operation section is installed in the vehicle 200. The operation section 220 receives an operation performed by the user, and outputs operation information to the control unit 210. The operation information indicates contents of the received user operation. The operation information includes at least information indicating the operation performed by the operation section 220. The operation section 220 may be implemented by a switch such as a push-button switch that detects pressing force or a touch switch that detects touch. In addition, the operation section 220 may be implemented by a camera that detects movement of the body of the user and makes it possible to operate the device by gesture. In addition, the operation section 220 may be implemented by a microphone that collects voice of the user and makes it possible to operate the device by voice.

For example, the operation section 220 may be a door lock operation section that manages whether to open or close a door lock of the vehicle 200. The door lock operation section receives a locking operation/unlocking operation, and outputs the received operation to the control unit 210 as operation information. In addition, the operation section 220 may be an engine operation section that manages whether to start or stop the engine (an example of the driving source) of the vehicle 200. The engine operation section receives an operation of starting/stopping the engine, and outputs the received operation to the control unit 210 as the operation information. In addition, the operation section 220 may be an electronic part operation section that manages whether or not to supply electric power to a predetermined electronic part installed in the vehicle 200. The electronic part operation section receives an operation of starting/stopping supply of electric power to the predetermined electronic part, and outputs the received operation to the control unit 210 as operation information.

For example, the control unit 210 and the operation section 220 are connected via a communication network. For example, the communication network may be an in-vehicle communication network that meets any standard such as a Controller Area Network (CAN), a Local Interconnect Network (LIN), or a local area network (LAN).

### 2. Technical Problem

Execution of the unnecessary authentication process results in waste of electricity and increase in processing load, with regard to wireless communication for authentication between the portable device 100 and the control unit 210 of the vehicle 200. Here, the authentication process is used for checking validity of the control of the control unit 210 when the control is performed by the control unit 210. In the case where the authentication process succeeds, the control unit 210 performs predetermined control. This makes it possible to enhance security.

For example, in the case of performing control to open the door lock of the vehicle 200, the authentication process is performed on the basis of a distance between the portable device 100 and the control unit 210. This makes it possible to enhance security. Specifically, for example, by using the authentication process based on a distance, it is possible to reduce a possibility of authenticatee impersonation such as a relay attack, which is a technique of indirectly performing communication between the portable device 100 and the control unit 210 by using a relay and improperly making the authentication successful. This makes it possible to enhance security.

However, depending on contents of the control, sometimes the authentication process that ensures a high level of security is not necessary, or another authentication process, which is different from the predetermined authentication process, is used. Therefore, sometimes the predetermined authentication process is not necessary. If an authentication result is not used but the authentication process is performed, this results in waste of electricity, and such a situation is not preferable.

Therefore, according to the present invention, control is performed in such a manner that the authentication process for authenticating another device is not performed in the case where a predetermined condition is satisfied. This makes it possible to prevent the unnecessary authentication process from being executed.

### 3. Operation Process Example

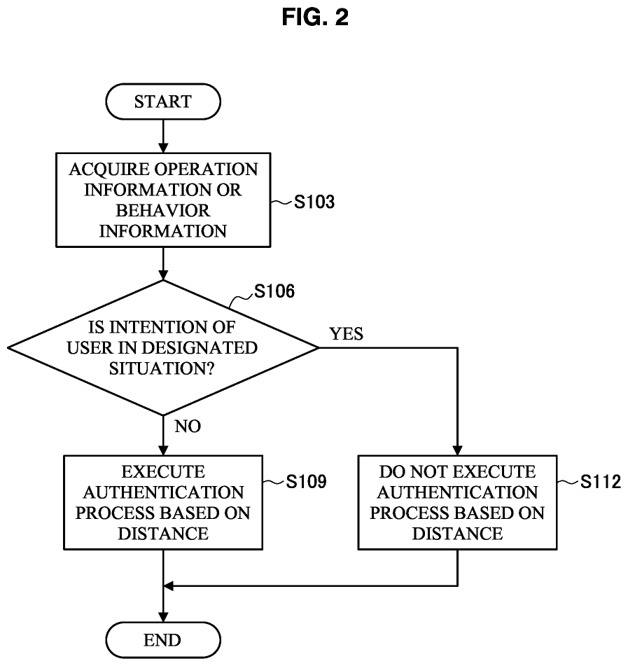

Next, with reference to FIG. 2, details of an operation process of the control unit 210 included in the system 1 according to an embodiment of the present invention will be described. FIG. 2 is a flowchart illustrating an example of a flow of the operation process of the control unit 210 according to the present embodiment.

According to the present embodiment, an authentication process based on a distance between the portable device 100 and the control unit 210 is executed as an example of the authentication process. It is possible for the control unit 210 to ensure security and reduce electric power consumption by appropriately controlling the execution of the authentication process.

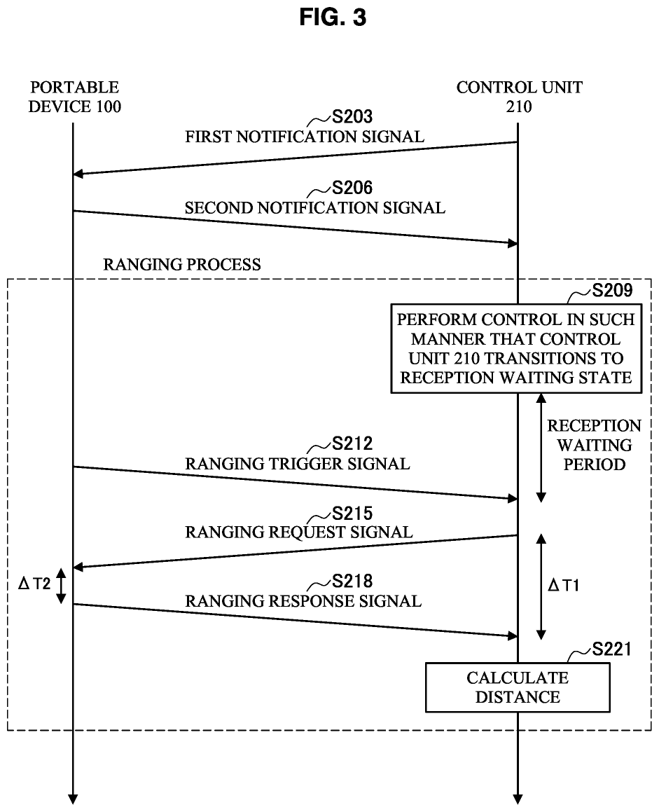

Note that, in the present specification, the “authentication process based on a distance” includes a ranging process of measuring the distance between the portable device 100 and the control unit 210, and an authentication process of performing authentication on the basis of the distance measured through the ranging process. Details of the ranging process will be described later with reference to FIG. 3. In the latter authentication process, the control unit 210 authenticates the portable device 100 in accordance with whether or not the measured distance satisfies a predetermined condition (which is a predetermined condition for authentication, and is also referred to as an authentication condition in this specification). For example, the control unit 210 determines that the authentication succeeds if the measured distance is a predetermined value or less. If not, the control unit 210 determines that the authentication ends in failure. In addition, if the measured distance falls within a predetermined range, the control unit 210 may determine that authentication for performing corresponding predetermined control succeeds. For example, in the case where a distance between the user carrying the portable device 100 and the vehicle 200 in which the control unit 210 is installed falls within the predetermined distance, the control unit 210 determines that authentication for controlling the light installed in the vehicle 200 and causing the light to turn on succeeds, and the control unit 210 performs control in such a manner that the light is turned on. Next, in the case where the user approaches the vehicle 200 more, the control unit 210 may determine that authentication for controlling the door lock and opening the door lock of the vehicle 200 succeeds, and may perform control in such a manner that the door lock is opened.

As illustrated in FIG. 2, the control unit 210 according to the present embodiment first acquires operation information received by the operation section 220 installed in the vehicle 200 or behavior information indicating behavior of the user (Step S103). The operation information includes at least information indicating an operation performed on the operation section 220.

The control unit 210 may detect an operation performed on the operation section 220 by acquiring the operation information from the operation section 220. The operation information is information indicating contents of the operation performed on the operation section 220 (an example of information indicating contents of control over the mounted device). For example, with reference to the operation information output from the operation section 220, the control unit 210 may detect an operation of opening/closing the door lock, an operation starting/stopping supply of electric power to the predetermined electronic part, or an operation of starting/stopping the engine.

In addition, the control unit 210 may acquire the behavior information indicating behavior of the user, from the portable device 100. For example, the behavior information may include information including movement of the body of the user. Any frequency band can be used by the portable device 100 to transmit a signal including the behavior information. For example, the signal including the behavior information may be transmitted by using a same frequency band as the ranging signal, or a different frequency band from the ranging signal. In addition, the signal including the behavior information may be transmitted as the UWB signal, an LF band signal, an RF band signal, or a Bluetooth Low Energy (BLE) (registered trademark) signal.

In addition, any other signal may also serve as the signal including the behavior information. Another example of any signal is a response signal corresponding to a wake-up signal for instructing to activate the device. It is also possible to transmit/receive the wake-up signal for instructing to activate the device, and the response to the wake-up signal between the portable device 100 and the control unit 210. The wake-up signal can cause a receiver to wake up from a sleep mode.

Examples of the response to the wake-up signal include an acknowledgment (ACK) signal that indicates activation, and a negative acknowledgement (NACK) signal that indicates non-activation.

Alternatively, another example of any signal may be a signal for request response authentication. For example, it is assumed that the request response authentication is performed between the portable device 100 and the control unit 210 before the authentication based on the distance. The request response authentication is a method in which an authenticator (for example, the control unit 210 according to the present embodiment) generates an authentication request signal and transmits the generated authentication request signal to an authenticatee (for example, the portable device 100 according to the present embodiment), the authenticatee generates an authentication response signal on the basis of the authentication request signal and transmits the generated authentication response signal to the authenticator, and the authenticator authenticates the authenticatee on the basis of the authentication response signal. The authentication request signal is random numbers, and is changed with each authentication. Accordingly, the request response authentication is resistant to a replay attack. In addition, the authentication response signal is generated on the basis of the information regarding the authenticatee. For example, the information regarding the authenticatee is identification information (identifier, ID), a password, or the like for identifying the portable device 100. In other words, the ID and the password themselves are not transmitted/received. This makes it possible to reduce a possibility of eavesdropping. It is possible to further enhance security by performing authentication based on the distance, in addition to the request response authentication. For example, in the case where the request response authentication is performed between the portable device 100 and the control unit 210 before the authentication based on the distance, the behavior information may be transmitted in such a manner that the behavior information is attached to the authentication response signal transmitted from the portable device 100.

Next, the control unit 210 determines whether or not intention of the user is in a designated situation (Step S106). According to the present embodiment, the condition that the intention of the user is in the designated situation is an example of the predetermined condition for determining whether or not to execute the predetermined authentication process (here, the authentication process based on a distance). The intention of the user is the user's request to a usage target (here, the vehicle 200). With regard to the intention of the user, the control unit 210 estimates what kind of operation (control) the user wants the usage target to perform, on the basis of operation information indicating contents of an operation performed by the user on the operation section 220, or behavior information indicating behavior of the user. For example, the behavior information may include information including a movement of the body of the user. It is also assumed that the user intentionally makes a pre-designated motion to express some kind of intention. It is possible for the control unit 210 to estimate the intention of the user more accurately, on the basis of information including such a movement of the body. For example, with reference to the operation information or the behavior information, the control unit 210 estimates that the intention of the user is to perform control to open/close the door lock, to perform control to start/stop supply of electric power to the predetermined electronic part, to perform control to turn on/off the light, or to perform control to start/stop the engine.

Next, the control unit 210 determines whether or not the intention of the user is in the designated situation. According to the present embodiment, for example, a situation where the predetermined authentication process (here, the authentication process based on a distance) is not performed is designated in advance as the above-described “situation”. For example, a situation where it is not necessary to perform control to add value to operations of the mobile object instead of controlling the operations of the mobile object, is designated. More specifically, examples of the above-described value adding control include control over whether to close the door lock, control over whether to start/stop supply of electric power to the predetermined electronic part, control over whether to turn on/off the light, or control over whether to start/stop the engine. Note that, the control unit 210 may take a current state of the vehicle 200 into consideration when estimating the intention of the user. Examples of the current state of the vehicle 200 include a state indicating whether or not the door lock is closed, a state indicating whether or not the engine has been started, a state indicating whether or not electric power has been supplied to the predetermined electronic part, and other states.

Next, in the case where it is determined that the intention of the user is in the designated situation (YES in Step S106), the control unit 210 does not execute the authentication process based on the distance (Step S112). This allows the control unit 210 to prevent the unnecessary authentication process from being executed and reduce electric power consumption. As described above, the authentication process based on the distance includes the ranging process of measuring the distance between the portable device 100 and the control unit 210, and the authentication process of performing authentication on the basis of the distance measured through the ranging process. For example, the control unit 210 may prevent execution of the authentication process based on the distance by transmitting or receiving no information to be used for the ranging process. It can be said that, the wording “transmitting or receiving no information to be used for the ranging process” means that the communication is non-executable. In addition, it can be said that the wording “prevent execution of the authentication process based on the distance” means that the authentication process based on the distance is non-executable. More specifically, the control unit 210 makes the communication non-executable by supplying no electric power to the wireless communication section 211. In addition, the control unit 210 may make the communication non-executable by preventing the wireless communication section 211 from transmitting the predetermined signal to be used for the ranging process. In addition, the control unit 210 may make the communication non-executable by preventing the wireless communication section 211 from receiving the predetermined signal to be used for the ranging process. Examples of preventing the wireless communication section 211 from receiving the signal include a situation where the received signal is not sampled, a situation where information obtained through the sampling is not output to a process in a subsequent stage (the control section 213), and other situations. The sampling of the signal means import of the signal. The process in the subsequent stage is a process using the imported signal. Details of the ranging process will be described later with reference to FIG. 3.

On the other hand, in the case where it is determined that the intention of the user is not in the designated situation (NO in Step S106), the control unit 210 executes the authentication process based on the distance (Step S109).

Ranging Process

Next, the ranging process included in the “authentication process based on the distance” in Step S109 and Step S112 will be described with reference to FIG. 3. FIG. 3 is a sequence diagram illustrating an example of a flow of the ranging process according to the present embodiment.

In this sequence, any other signal is transmitted and received between the portable device 100 and the control unit 210 before the ranging process, for example. For example, the request response authentication is performed between the portable device 100 and the control unit 210. In addition, it is also possible to transmit/receive a wake-up signal for instructing to activate the device, and a response to the wake-up signal between the portable device 100 and the control unit 210. Alternatively, before the ranging process, a response to the wake-up signal may be communicated and the request response authentication may be performed between the portable device 100 and the control unit 210.

In addition, a signal transmitted from one device to another device with regard to the response to the wake-up signal and the request response authentication is also referred to as a first notification signal in this specification. In addition, a signal transmitted from the device that has received the first notification signal to the device that has transmitted the first notification signal is also referred to as a second notification signal. Any frequency band can be used for transmitting the first and second notification signals. For example, the notification signal may be transmitted by using a same frequency band as the ranging signal, or a different frequency band from the ranging signal. In addition, the notification signal may be transmitted as the UWB signal, the LF band signal, the RF band signal, or the Bluetooth Low Energy (BLE) (registered trademark) signal.

First, the control unit 210 transmits the first notification signal (Step S203).

Next, when the first notification signal is received, the portable device 100 transmits the second notification signal (Step S206).

Next, when the second notification signal is received, the control unit 210 performs control in such a manner that the control unit 210 transitions to a reception waiting state of waiting for reception of a ranging trigger signal (Step S209). According to the present embodiment, for example, the portable device 100 transmits a signal for instructing to transmit the first ranging signal (which is a signal that triggers the ranging, and is also referred to as the “ranging trigger signal” in this specification) before the control unit 210 transmits the first ranging signal. In this case, the control unit 210 waits for reception of the ranging trigger signal.

The wording “waits for reception” means a situation where a process of importing a signal starts when the signal is received. In addition, the process of waiting for reception includes various kinds of processes for obtaining a desired signal. Examples of the various kinds of processes include a process in which an antenna of the wireless communication section 211 receives a signal, a process in which the wireless communication section 211 samples the received signal, a process in which the control section 213 performs a process based on a signal obtained through the sampling, and other processes. Examples of the process based on a signal obtained through the sampling include a process of determining whether or not the desired signal is obtained. The state of waiting for reception is also referred to as the reception waiting state. In addition, a period in which the device is in the reception waiting state is also referred to as the reception waiting period. The control unit 210 according to the present modification transitions to the state of waiting for reception of the ranging trigger signal at any timing, and waits for reception of the ranging trigger signal. The state of waiting for reception of the ranging trigger signal is a state where the wireless communication section 211 is continuously sampling signals received by the antenna, for example.

Note that, before the transition to the reception waiting state (before the control unit 210 starts waiting for reception), the control unit 210 is controlled in such a manner that the reception waiting state is suspended, such as a state where the signal received by the antenna is not sampled, or a state where the process based on the signal obtained through the sampling is not performed, for example. The state where the process based on the signal obtained through the sampling is not performed is a state where information obtained through the sampling is not transmitted to a process in a subsequent stage, for example. Such a state is also referred to as a normal state in this specification. Electric power consumed in the normal state is lower than the reception waiting state.

A timing of transitioning to the reception waiting state may be a timing of receiving the authentication response signal, a time period of authenticating the portable device 100 on the basis of the authentication response signal, or a timing after the authentication ends. Alternatively, the timing of transitioning to the reception waiting state may be a timing of receiving a response to the wake-up signal, a time period of determining whether or not the received response is the ACK signal, or a timing after the determination ends. The control unit 210 starts waiting for reception on the basis of the response to the wake-up signal or the request response authentication. This makes it possible to shorten the reception waiting period.

Next, the portable device 100 transmits the ranging trigger signal (Step S212). For example the UWB signal is used for the ranging trigger signal.

Next, when the ranging trigger signal is received, the control unit 210 transmits a ranging request signal for requesting transmission of the second ranging signal, as the first ranging signal (Step S215). The reception waiting period ends at a timing of receiving the ranging trigger signal. In other words, the control unit 210 performs control in such a manner that the control unit 210 transitions to a transmission state of transmitting the ranging request signal when the ranging trigger signal is received. The transmission state is a state of executing various kinds of processes of outputting the ranging request signal as a radio wave from the antenna. Examples of the various kinds of processes include generation of a transmission signal, modulation based on the transmission signal, transmission of the radio wave from the antenna, and the like.

Next, when the ranging request signal (first ranging signal) is received from the control unit 210 and a time period ΔT2 elapses after the reception of the ranging request signal, the portable device 100 transmits a ranging response signal in response to the ranging request signal, as the second ranging signal (Step S218). The time period ΔT2 is a pre-designated time period. The time period ΔT2 is set to be longer than a time period, which is assumed to be required for a process from time when the portable device 100 receives the first ranging signal to time when the portable device 100 transmits the second ranging signal. This makes it possible to certainly finish preparation for transmission of the second ranging signal before the time period ΔT2 elapses after reception of the first ranging signal. The time period ΔT2 may also be known to the control unit 210.

Next, when the ranging response signal (second ranging signal) is received, the control unit 210 calculates a distance between the portable device 100 and the control unit 210 (Step S221). Specifically, the control unit 210 measures the time period ΔT1 from transmission time of the first ranging signal to reception time of the second ranging signal, and calculates the distance on the basis of the measured time period ΔT1 and the known time period ΔT2. The control unit 210 may calculate time taken to transmit or receive a one-way signal by subtracting ΔT2 from ΔT1 and dividing the subtracted value by 2, and then calculate the distance between the portable device 100 and the control unit 210 by multiplying the calculated time by speed of the signal.

Note that, the time period ΔT2 does not have to be known to the control unit 210. For example, the portable device 100 may measure the time period ΔT2 and report the measured time period ΔT2 to the control unit 210. Such a report may be made by transmitting a data signal including information obtained by encrypting information indicating the time period ΔT2. The data signal is another example of the signal for the ranging process. The data signal is a signal that stores and carries data. The data signal is configured in the frame format that includes the payload part for storing the data, for example. In addition, the data signal may be transmitted and received as the UWB signal.

The details of the ranging process has been described above.

For example, the control unit 210 may treat a situation where the first ranging signal is not transmitted, as the situation where the authentication process based on the distance illustrated in Step S112 of FIG. 2 is non-executable. In addition, the control unit 210 may make the authentication process based on the distance illustrated in Step S112 of FIG. 2 non-executable, by preventing the ranging request signal (first ranging signal) from being transmitted even if the ranging trigger signal is received from the portable device 100.

The control unit 210 may determine whether or not the intention of the user is the designated situation in Step S106, before, after, or in parallel with the control performed to transition to the reception waiting state. In addition, the behavior information indicating behavior of the user may be attached to the second notification signal illustrated in Step S206 of FIG. 3.

In addition, the control unit 210 may make the authentication process based on the distance illustrated in Step S112 of FIG. 2 non-executable by not performing control for the reception waiting state illustrated in Step S209 of FIG. 3, or by suspending the reception waiting state. Specifically, the wording “suspending the reception waiting state” means that the control unit 210 returns to the normal state. By shortening or eliminating the reception waiting period, it is also possible to reduce electric power consumption. In particular, a large effect of reducing electric power consumption is obtained in the case where the UWB signal is used for the ranging trigger signal. Specifically, one of features of the UWB is an ultra-wide frequency band while sampling frequency of the receiver is set depending on a maximum value of frequency of a carrier wave. Therefore, the receiver consumes a large amount of electric power. Therefore, in the case of using the UWB, it is possible to drastically reduce electric power to be consumed by the control unit 210 by shortening the reception waiting period in which large electric power is consumed, or by performing control in such a manner that the control unit 210 does not transition to the reception waiting state.

### 4. Modifications

In the above-described embodiment, the authentication process based on the distance is made non-executable in the case where the intention of the user is in the designated situation (in the case where the predetermined condition is satisfied). However, the present invention is not limited thereto. For example, in the case where the intention of the user is in the designated situation, it is possible to suppress reduction in security by executing a specific authentication process other that the authentication process based on the distance. Examples of the specific authentication process include the request response authentication. In addition, the specific authentication process may be performed by using any frequency band. For example, signals may be transmitted by using a same frequency band as the ranging signal, or a different frequency band from the ranging signal. In addition, the signals used for the specific authentication process may be transmitted as the UWB signal, the LF band signal, the RF band signal, or the Bluetooth Low Energy (BLE) (registered trademark) signal.

In addition, in the above-described embodiment, the portable device 100 including the behavior information acquisition section 140 has been described with reference to FIG. 1. However, the present invention is not limited thereto. The portable device 100 does not have to include the behavior information acquisition section 140. In the case where the portable device 100 does not include the behavior information acquisition section 140, the control unit 210 may estimate the intention of the user on the basis of the operation information acquired from the operation section 220.

### 5. Supplement

Although details of the preferable embodiments of the present invention have been described above with reference to the appended drawings, the present invention is not limited thereto. It will be clear to a person of ordinary skill in the art of the present invention that various modifications and improvements may be obtained within the scope of the technical idea recited by the scope of the patent claims, and these should obviously be understood as belonging to the range of the technology of the present invention.

For example, although the example in which the authenticator (that is, the control unit 210 of the vehicle 200) transmits the first ranging signal has been described in the above embodiment, the present invention is not limited thereto. For example, it is also possible for the authenticatee (that is, the portable device 100) to transmit the first ranging signal. When the first ranging signal is received from the portable device 100, the control unit 210 transmits the second ranging signal in response to the first ranging signal. When the second ranging signal is received, the portable device 100 measures the time period ΔT1 that is a time period from transmission time of the first ranging signal to reception time of the second ranging signal. Next, the portable device 100 transmits the data signal including information obtained by encrypting information indicating the measured time period ΔT1. On the other hand, the control unit 210 measures the time period ΔT2 from reception time of the first ranging signal to transmission time of the second ranging signal. Next, when the data signal is received from the portable device 100, the control unit 210 calculates the distance between the portable device 100 and the control unit 210 on the basis of the measured time period ΔT2 and the time period ΔT1 indicated by the data signal received from the portable device 100. For example, time taken to transmit or receive a one-way signal is calculated by subtracting ΔT2 from ΔT1 and dividing the subtracted value by 2, and then the distance between the portable device and the control unit is calculated by multiplying the calculated time by speed of the signal. As described above, in the case where the directions of transmitting and receiving the first ranging signal and the second ranging signal are reversed, the control unit 210 performs control in such a manner that the control unit 210 transitions to the waiting state of waiting for the first ranging signal transmitted from the portable device 100. The control unit 210 may transition to the waiting state of waiting for the first ranging signal at any timing. The control unit 210 determines whether or not the intention of the user is in the designated situation even in the above-described case. In the case where the intention of the user is in the designated situation, the transition to the waiting state of waiting for the first ranging signal is canceled or suspended. This makes it possible to reduce electric power consumption.

In addition, in the above-described embodiments, the authentication process based on the distance is properly controlled depending on the predetermined condition. However, the present invention is not limited thereto. For example, it is also possible to designate a condition for determining whether or not to execute another authentication process such as the request response authentication, as the predetermined condition. In the case where such a condition is satisfied, the control unit 210 makes other corresponding authentication processes non-executable. This makes it possible to reduce electric power consumption.

In addition, although the example in which the portable device 100 serves as the authenticatee and the control unit 210 of the vehicle 200 serves as the authenticator has been described in the above embodiment, the present invention is not limited thereto. The roles of the portable device 100 and the control unit 210 of the vehicle 200 may be reversed, or the roles may be switched dynamically. In addition, the ranging and authentication may be performed between the control units 210 of the vehicles 200.

In addition, for example, although the example in which the present invention is applied to the smart entry system has been described in the above embodiment, the present invention is not limited thereto. The present invention is applicable to any system that performs the ranging and authentication by transmitting/receiving signals. Examples of the target to be used by the user include a drone, a vehicle, a ship, an airplane, a building (such as house), a robot, a locker, a home appliance, and the like. In addition, the present invention is applicable to a pair of any two devices selected from a group including portable devices, vehicles, ships, airplanes, smartphones, drones, buildings, robots, lockers, home appliances, and the like. Note that, the pair may include two device of a same type, or may include two devices of different types. In this case, one of the devices operates as a first communication device and the other device operates as a second communication device.

In addition, for example, in the above embodiment, the standard using the UWB has been exemplified as the wireless communication standard. However, the present invention is not limited thereto. For example, it is also possible to use a standard using infrared as the wireless communication standard.

In addition, for example, although the above embodiment has been described on the assumption that the control section 213 is configured as the ECU and controls overall operation of the control unit 210, the present invention is not limited thereto. For example, the wireless communication section 211 may include an ECU. In addition, the wireless communication section 211 may execute the process of determining whether or not the predetermined condition is satisfied on the basis of the operation information or the behavior information, and may control the authentication process based on a distance. The predetermined condition may be a condition that intention of the user is in the designated state. For example, the process of controlling the authentication process based on the distance is a process of controlling whether or not to transition to the reception waiting state. In addition, the wireless communication section 211 may execute the process based on the signal obtained by sampling the signal received from the antenna. Examples of the process based on the signal obtained through the sampling include a process of determining whether or not the desired signal is obtained. In addition, the control unit 210 does not have to include the wireless communication section 211. In this case, the wireless communication section 211 installed in the vehicle 200 and the control unit 210 may be connected via an in-vehicle communication network that meets any standard such as a Controller Area Network (CAN), a Local Interconnect Network (LIN), or a local area network (LAN).

Note that, the series of processes performed by the devices described in this specification may be achieved by any of software, hardware, and a combination of software and hardware. A program that configures the software is stored in advance in, for example, a recording medium (non-transitory medium) installed inside or outside the devices. In addition, for example, when a computer executes the programs, the programs are read into RAM, and executed by a processor such as a CPU. The recording medium may be a magnetic disk, an optical disc, a magneto-optical disc, flash memory, or the like, for example. Alternatively, the above-described computer program may be distributed via a network without using the recording medium, for example.

Further, in this specification, the processes described using the sequence diagrams and flowcharts are not necessarily executed in the order illustrated in the drawings. Some processing steps may be executed in parallel. In addition, additional processing steps may be employed and some processing steps may be omitted.

What is claimed is:

1. A control device comprising
a control section configured to perform an authentication process of authenticating another device by using information obtained through communication with the other device,
wherein, in a case where a predetermined condition is satisfied, the control section performs control in such a manner that the authentication process is not performed.

2. The control device according to claim 1,
wherein, as the authentication process, the control section uses a process of authenticating the other device on a basis of a distance that has been measured by using the information.

3. The control device according to claim 1, wherein
the control target is installed in a target object, and
the control section uses a condition that intention of a user who uses the target object is in a designated situation, as the predetermined condition.

4. The control device according to claim 3,
wherein the control section determines whether or not the intention of the user is in the designated situation in accordance with a content of control over a mounted device, which is a device installed in the target object.

5. The control device according to claim 4, wherein
the mounted device is an operation section that is installed in the target object and that receives an operation, and
when the operation performed on the operation section is detected, the control section determines that the intention of the user is in the designated situation.

6. The control device according to claim 4, wherein
the mounted device includes a drive operation section that is installed in the target object and that receives at least an operation of staring or stopping a driving source of the target object, and
when the operation performed on the drive operation section is detected, the control section determines that the intention of the user is in the designated situation.

7. The control device according to claim 4, wherein
the mounted device includes a lock operation section that receives at least an operation of closing or opening a lock of the target object, and
when the operation performed on the lock operation section is detected, the control section determines that the intention of the user is in the designated situation.

8. The control device according to claim 3,
wherein the control section determines whether or not the intention of the user is in the designated situation in accordance with behavior information acquired from the other device, the behavior information indicating behavior of the user.

9. The control device according to claim 8,
wherein the control section acquires information including a movement of a body of the user, as the behavior information.

10. The control device according to claim 8,
wherein the control section determines that the intention of the user is in the designated situation in a case where the behavior indicated by the behavior information is at least any one of behavior of performing control to start or stop the driving source that drives the target object, behavior of performing control to close or open the lock device installed in the target object, behavior of performing control to supply electric power to a predetermined electronic part installed in the target object, and behavior of performing control to turn on a light installed in the target object.

11. The control device according to claim 2,
wherein, in a case where the predetermined condition is satisfied, the control section performs control in such a manner that specific authentication for authenticating the other device is performed in accordance with information, which is different from the information used in the authentication process.

12. The control device according to claim 1,
wherein the other device is a device to be carried by the user who uses the target object including the control device.

13. A control method comprising
performing control in such a manner that a processor performs an authentication process of authenticating another device by using information obtained through communication with the other device,
wherein, in a case where a predetermined condition is satisfied, control is performed in such a manner that the authentication process is not performed.
